(19) United States
(12) Patent Application Publication
(10) Pub. No.: US 2015/0349819 A1
(43) Pub. Date: Dec. 3, 2015

(54) INTERMODULATION CANCELLATION DEVICE

(71) Applicant: Wuhan Fingu Electronic Technology Co., Ltd., Wuhan (CN)

(72) Inventor: Qingnan MENG, Wuhan (CN)

(21) Appl. No.: 14/819,460

(22) Filed: Aug. 6, 2015

Related U.S. Application Data
(63) Continuation-in-part of application No. PCT/CN2013/074762, filed on Apr. 26, 2013.

(30) Foreign Application Priority Data
Feb. 7, 2013 (CN) 201310048951.1

(51) Int. Cl. H04B 1/10; H04L 5/14

(52) U.S. Cl. CPC H04B 1/1027; H04L 5/14

(57) ABSTRACT

An intermodulation cancellation device, including: a power coupler, a regulating module, a nonlinear device, and an input/output port. When in use, a part of a transmitted signal including an intermodulation signal is coupled from a passive device by the power coupler via the input/output port. The coupled transmitted signal is processed for a first time by the regulating module and the nonlinear device, reflected at an end of the intermodulation cancellation device, and then processed for a second time to produce a power signal including a second intermodulation cancellation signal. The second intermodulation cancellation signal of the power signal and the intermodulation signal of the transmitted signal of the passive device have the same frequency and level and opposite phases. The power signal is superimposed on the transmitted signal of the passive device and a superimposed signal is output to the passive device via the input/output port.

### CROSS-REFERENCE TO RELATED APPLICATIONS

This application is a continuation-in-part of International Patent Application No. PCT/CN2013/074762 with an international filing date of Apr. 26, 2013, designating the United States, now pending, and further claims priority benefits to Chinese Patent Application No. 201310048951.1 filed Feb. 7, 2013. The contents of all of the aforementioned applications, including any intervening amendments thereto, are incorporated herein by reference. Inquiries from the public to applicants or assignees concerning this document or the related applications should be directed to: Matthias Scholl P.C., Attn.: Dr. Matthias Scholl Esq., 245 First Street, 18th Floor, Cambridge, Mass. 02142.

### BACKGROUND OF THE INVENTION

1. Field of the Invention

The invention relates to the communication field, and more particularly to an intermodulation cancellation device.

2. Description of the Related Art

In a typical antenna feed system, the receiving pathway and the transmitting pathway are combined and share a common antenna. The signal power of the transmitting pathway is much higher than the signal power of the receiving pathway, and a transmitted signal produces high level of an intermodulation signal when passing the passive nonlinear component. At the antenna end, the intermodulation signal falls into the receiving pathway and produces intermodulation interference, making the antenna feed system fail to work normally. Thus, the level of the passive intermodulation signal produced by the transmitting pathway is required to be as low as possible during the operation of the passive component, so as to prevent the intermodulation signal from falling into the receiving pathway and to avoid the interference on the receiving pathway.

### SUMMARY OF THE INVENTION

In view of the above-described problems, it is one objective of the invention to provide an intermodulation cancellation device that has a simple structure, is convenient in operation, and is able to cancel the intermodulation signal of the passive device within the whole working frequency band.

To achieve the above objective, in accordance with one embodiment of the invention, there is provided an intermodulation cancellation device for a passive device, comprising: a power coupler, a regulating module, a nonlinear device, an input/output port, and an end. The input/output port functions as a common port for input and output, and the input/output port is disposed at one port of the power coupler. In use: a part of a transmitted signal comprising an intermodulation signal is coupled from a passive device by the power coupler via the input/output port, and a level value of a coupled transmitted signal is much lower than that of the transmitted signal before coupling, and an intermodulation signal of the coupled transmitted signal is negligible. The coupled transmitted signal is processed for a first time by the regulating module and the nonlinear device, respectively, and a first intermodulation cancellation signal is produced by the nonlinear device after the first processing. The coupled transmitted signal after the first processing is reflected at the end of the intermodulation cancellation device; the coupled transmitted signal and the first intermodulation cancellation signal produced by the nonlinear device are processed by the nonlinear device and the regulating module for a second time to produce a power signal comprising a second intermodulation cancellation signal, the second intermodulation cancellation signal of the power signal and the intermodulation signal of the transmitted signal of the passive device have the same frequency and level and opposite phases. The power signal is superimposed on the transmitted signal of the passive device by the power coupler and a superimposed signal is output to the passive device via the input/output port.

In a class of this embodiment, the intermodulation cancellation device is disposed at an antenna port of the passive device, and the transmitted signal is coupled at the antenna port of the passive device by the power coupler. The power signal coupled by the antenna port and the excitation signal of the intermodulation signal produced by the passive device have the same frequency, so that the intermodulation cancellation signal produced by the intermodulation cancellation device has the same frequency as that of the intermodulation signal of the passive device, thereby ensuring successful cancellation.

In a class of this embodiment, a plurality of the intermodulation cancellation devices is disposed at the same antenna port of the passive device for reaching superimposition effect on the intermodulation signal of the transmitted signal. Multiple intermodulation cancellation signals are produced by the multiple (two or more) intermodulation cancellation devices, and the intermodulation cancellation signals are superimposed to reach a better cancellation effect of the intermodulation signal.

In a class of this embodiment, the power signal is coupled by the power coupler within a transmitting frequency band of the passive device.

In a class of this embodiment, a coupling amount of the power coupler is between 16 and 60 dB, thereby not effecting the transportation of the main signal.

In a class of this embodiment, the nonlinear device functions in that in condition of an input power of between 0.01 and 100 mW in the absence of a DC bias, an intermodulation signal produced by the nonlinear device has an order of magnitude slightly higher than that of a signal to be cancelled, and the order of magnitude is between 0.01 and 100 pW. Thus, only a small amount of the transmitted/received signal is required to produce the intermodulation cancellation signal.

In a class of this embodiment, the regulating module comprises: a phase regulator and a power attenuator; the phase regulator is configured to regulate phases of the coupled transmitted signal and the first intermodulation cancellation signal produced by the nonlinear device; and the power attenuator is configured to regulate levels of the coupled transmitted signal and the first intermodulation cancellation signal produced by the nonlinear device. The intermodulation cancellation signal and the intermodulation signal have the same level and opposite phases.

In a class of this embodiment, the intermodulation cancellation device is formed by series electric connection of the power coupler, the phase regulator, the power attenuator, and the nonlinear device; and the end of the intermodulation cancellation device is grounded or disconnected, thereby reflecting the coupled transmitted signal after the first processing at the end of the intermodulation cancellation device.

It is another objective of the invention to provide a duplexer comprising the above intermodulation cancellation device that is able to cancel the passive intermodulation signal of the transmitting pathway at the antenna port of the duplexer and ensure the normal operation of the receiving pathway and the transmitting pathway of the antenna feed system.

To achieve the above objective, in accordance with one embodiment of the invention, there is provided a duplexer comprising the intermodulation cancellation device. The duplexer comprises: a transmitting port, a receiving port, the antenna port, and the intermodulation cancellation device. The intermodulation cancellation device comprises: the power coupler, the regulating module, the nonlinear device, the input/output port, and the end. The intermodulation cancellation device is disposed at the antenna port. The input/output port of the intermodulation cancellation device functions as the common port of the input and the output, and the input/output port is disposed at one port of the power coupler. In use: a part of the transmitted signal comprising the intermodulation signal is coupled from the duplexer by the power coupler via the input/output port, and the level value of the coupled transmitted signal is much lower than that of the transmitted signal before coupling, and the intermodulation signal of the coupled transmitted signal is negligible. The coupled transmitted signal is processed for the first time by the regulating module and the nonlinear device, respectively, and the first intermodulation cancellation signal is produced by the nonlinear device after the first processing. The coupled transmitted signal after the first processing is reflected at the end of the intermodulation cancellation device. The coupled transmitted signal and the first intermodulation cancellation signal produced by the nonlinear device are processed by the nonlinear device and the regulating module for the second time to produce the power signal comprising the second intermodulation cancellation signal, the second intermodulation cancellation signal of the power signal and the intermodulation signal of the transmitted signal of the duplexer have the same frequency and level and opposite phases. The power signal is superimposed on the transmitted/received signal of the duplexer by the power coupler and the superimposed signal is output to the duplexer via the input/output port.

In a class of this embodiment, the intermodulation cancellation device is disposed at an antenna port of the duplexer, and the transmitted/received signal is coupled at the antenna port of the duplexer by the power coupler.

In a class of this embodiment, a plurality of the intermodulation cancellation devices is disposed at the same antenna port of the duplexer for reaching superimposition effect on the intermodulation signal of the transmitted signal.

In a class of this embodiment, the power signal is coupled by the power coupler within a transmitting frequency band of the duplexer.

In a class of this embodiment, a coupling amount of the power coupler is between 16 and 60 dB.

In a class of this embodiment, the nonlinear device functions in that in condition of an input power of between 0.01 and 100 mW in the absence of a DC bias, an intermodulation signal produced by the nonlinear device has an order of magnitude slightly higher than that of a signal to be cancelled, and the order of magnitude is between 0.01 and 100 pW.

In a class of this embodiment, the regulating module comprises: a phase regulator and a power attenuator; the phase regulator is configured to regulate phases of the coupled transmitted signal and the first intermodulation cancellation signal produced by the nonlinear device; and the power attenuator is configured to regulate levels of the coupled transmitted signal and the first intermodulation cancellation signal produced by the nonlinear device.

In a class of this embodiment, the intermodulation cancellation device is formed by series electric connection of the power coupler, the phase regulator, the power attenuator, and the nonlinear device; and the end of the intermodulation cancellation device is grounded or disconnected.

It is still another objective of the invention to provide a method for cancel an intermodulation signal of a passive device. The method is able to cancel the intermodulation signal of the passive device within the working efficiency band and free from the limitation by the fixed order, and to ensure the normal operations of not only the passive device but also the receiving pathway and the transmitting pathway of the antenna feed system.

To achieve the above objective, in accordance with one embodiment of the invention, there is provided a method for cancel an intermodulation signal of a passive device. The method comprises the following steps:

1) coupling a part of a transmitted signal comprising an intermodulation signal from a passive device by an intermodulation cancellation device, wherein a level value of a coupled transmitted signal is much lower than that of the transmitted signal before coupling, and an intermodulation signal of the coupled transmitted signal is negligible;

2) processing the coupled transmitted signal for a first time by the intermodulation cancellation device to enable the coupled transmitted signal to produce a first power signal comprising a first intermodulation cancellation signal;

3) reflecting the first power signal at an end of the intermodulation cancellation device to return the first power signal along an original path, processing the coupled transmitted signal for a second time to enable the coupled transmitted signal to produce a second power signal comprising a second intermodulation cancellation signal, wherein the second intermodulation cancellation signal of the second power signal and the intermodulation signal of the transmitted signal in the passive device have the same frequency and level and opposite phases;

4) superimposing the second power signal on a transmitted/received signal of the passive device and outputting a superimposed signal from the intermodulation cancellation device to the passive device.

In a class of this embodiment, the transmitted/received signal is coupled by the intermodulation cancellation device within a transmitting frequency band of the passive device.

In a class of this embodiment, a coupling amount of the transmitted/received signal coupled by the power coupler is between 16 and 60 dB.

In a class of this embodiment, the regulating module comprises a phase regulator and a power attenuator; the phase regulator is configured to regulate phases of the coupled transmitted signal and the first intermodulation cancellation signal produced by the nonlinear device; and the power attenuator is configured to regulate levels of the coupled transmitted signal and the first intermodulation cancellation signal produced by the nonlinear device.

Principle of the production of the intermodulation cancellation signal is as follows: when two signals of different frequencies pass through the passive device, a new frequency signal is produced, and the newly formed frequency signal is the product of the intermodulation. The frequency of the intermodulation product is only related to the frequencies of the two input signals rather than the nonlinearity of the device. Thus, as long as the frequency of the input signal keeps constant, the frequency of the intermodulation product keeps that same. The amplitude of the intermodulation product is mainly affected by the amplitude of the input signal and the nonlinearity of the nonlinear device, the amplitude of the input signal is in positive relation with the amplitude of the intermodulation product, and the nonlinearity of the nonlinear device is in positive relation with the amplitude of the intermodulation production.

When two radio-frequency signals have equivalent frequencies and amplitude and exist 180 degree of the phase difference therebetween, the two radio-frequency signals can be interactively cancelled.

In the above described passive device, the transmitted signal produces the transmitted signal comprising the intermodulation signal when passing through the passive device, and the transmitted signal comprising the intermodulation signal is then input into the intermodulation cancellation device of the invention. A very small part of the transmitted signal is coupled by the intermodulation cancellation device, and to avoid the influence on the transportation of the original transmitted signal of the passive device, the coupling amount is between 16 and 60 dB, that is, the power of the coupled transmitted signal is smaller than 2.5% of that of the original transmitted signal, and the specific power value varies along with change of the power of the original power signal. After the phase regulation and the power attenuation, this part of the transmitted drives a nonlinear device having strong linearity to produce the power signal comprising the intermodulation cancellation signal. The power signal is reflected at the end of the circuit of the device and passes through the nonlinear device, the phase regulator, and the power attenuator again, the level of the produced power signal is much lower than the level of the transmitted signal of the antenna port, and the intermodulation cancellation signal and the intermodulation signal are equivalent in the frequency and the level and have a phase difference of 180 degree. The produced power signal and the transmitted signal are superimposed by the power coupler at the antenna port of the passive device, and the intermodulation signal and a very small amount of the transmitted signal are cancelled, so that interference of the intermodulation signal produced by the transmitting pathway on the receiving pathway during the operation of the passive device is reduced. The sequence of the phase regulation and the power attenuation in signal processing are not limited. Degrees of the phase adjustment and the power attenuation are based on the phase and the level of the passive intermodulation signal and are realized by an adjustable means, or setting a fixed value, or a combination of the two means.

The intermodulation cancellation device of the invention overcomes the problems in the prior art. The transmitted signal is coupled at the antenna port, which does not affect the normal operation of the passive device. The produced intermodulation cancellation signal is highly correlated with the intermodulation signal of the duplexer and the intermodulation signal can be cancelled within the whole working frequency band.

The intermodulation cancellation of the invention operates in a passive state, no additional power supplier is required, thereby decreasing the complexity of the circuit, improving the reliability, and reducing the production cost.

The input and output of the intermodulation cancellation device of the invention share one port, the intermodulation cancellation device only occupies a small space when being assembled, thereby not affecting the structural arrangement of the original passive device.

The intermodulation cancellation device is able to decrease the level of the passive intermodulation signal by producing the intermodulation cancellation signal having the same level and a phase of 180 degree different from the intermodulation signal. Due that both the phase and the level of the intermodulation cancellation signal can be regulated by the phase regulator and the power attenuator, the qualified rate of the product are easy to control, the production cost is reduced, which is of great significance to the production.

In addition, the intermodulation cancellation device of the invention is mainly used to intermodulation cancellation of the passive device, no additional power supply is required, and the production cost is reduced.

### BRIEF DESCRIPTION OF THE DRAWINGS

FIG. 1 is a structure diagram of a duplexer adopting an intermodulation cancellation device;

FIG. 2 is a schematic diagram of an intermodulation cancellation device;

FIG. 3 is a schematic diagram illustrating intermodulation cancellation principle of the intermodulation cancellation device in FIG. 1; and

FIG. 4 illustrates variation of an intermodulation value within a working frequency band before and after addition of the intermodulation cancellation device in FIG. 1.

### DETAILED DESCRIPTION OF THE EMBODIMENTS

For further illustrating the invention, experiments detailing an intermodulation cancellation device for a passive device are described hereinbelow combined with the drawings.

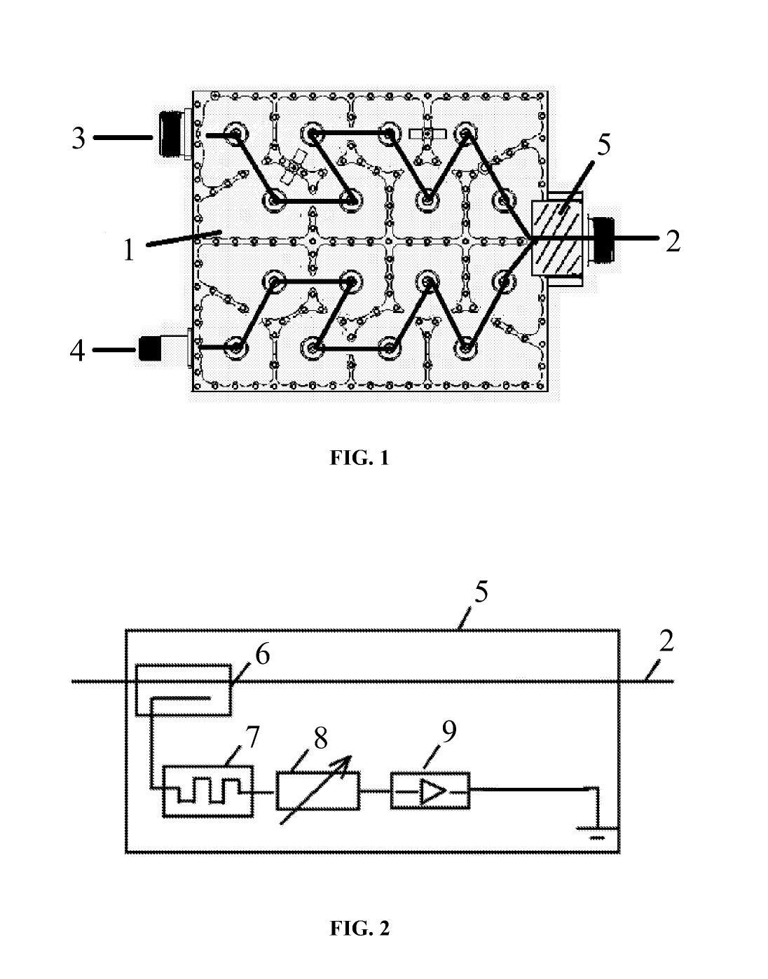

A duplexer 1 provided with an intermodulation cancellation device 5 is shown in in FIG. 1. The duplexer 1 comprises: an antenna port 2, a transmitting port 3, and a receiving port 4. When the duplexer 1 works, a signal is transmitted from the transmitting port 3 to the duplexer 1 where the transmitted signal is processed and then transmitted out via the antenna port 2. In the meanwhile, the antenna port 2 can also receive a signal. The received signal enters the duplexer 1 via the antenna port 2 and is then processed and output from the receiving port 4. Because a signal power of the transmitting pathway is much higher than that of the receiving pathway, an intermodulation signal caused by the passive nonlinearity falls into the receiving pathway at the antenna port 2, so that the intermodulation interference occurs which make the antenna feed system fails to work normally. Thus, the passive intermodulation level produced in the transmitting pathway is required to be as low as possible during the operation of the duplexer 1 in order to prevent the intermodulation signal from falling into the frequency band of the receiving pathway which otherwise may result in the interference of the receiving pathway. The intermodulation cancellation device 5 is configured to cancel the passive intermodulation signal produced by the transmitting pathway.

The intermodulation cancellation device 5 is disposed in the vicinity of the antenna port 2 of the duplexer 1. The input and output of the intermodulation cancellation device 5 share one port which is called input/output port. The intermodulation cancellation device 5 is connected to the antenna port 2 of the duplexer 1 via the input/output port. An input signal of the intermodulation cancellation device 5 is the transmitted signal of the antenna port 2, that is the transmitted signal comprising the intermodulation signal; and an output signal of the intermodulation cancellation device 5 is a transmitted signal comprising an intermodulation cancellation signal. The output signal of the intermodulation cancellation device 5 is output to the antenna port 2 of the passive device 1 via the input/output port for continuing the subsequent processing described in the above.

The intermodulation device 5 is disposed at the antenna port 2 of the duplexer 1, and only a power signal coupled at the antenna port 2 has the same frequency with an excitation signal of the intermodulation signal produced by the duplexer, so that the intermodulation cancellation signal for cancellation will has the similar frequency changes along with the intermodulation signal produced by the duplexer, otherwise the cancellation of the frequency changes fails.

FIG. 2 is a structure diagram of the intermodulation cancellation device 5. As shown in FIG. 2, the intermodulation cancellation device 5 comprises a series connection of a power coupler 6, a phase regulator 7, a power attenuator 8, and a nonlinear device 9, and an end of the nonlinear device 9 is grounded. The power coupler 6 is configured to couple the power signal within the transmitting frequency band, and adopts a structure form that has the power coupling effect and comprises, but not limited to, a microstrip, a probe, and a coupling loop. For the purpose of not affecting the transportation of the main signal, a coupling amount of the power coupler is between 16 and 60 dB, that is, the coupled signal power is smaller than 2.5% of the original signal power; and a specific power value varies along with the power of the original signal. The structure form of the phase regulator 7 comprises, but not limited to, a microstrip transmission line, a cable transmission lien, and an external phase shifter. The nonlinear device 9 comprises a component with relatively strong nonlinearity and functions in producing a relatively poor intermodulation signal at a low input power in the absence of DC bias, for example, when the input power is between 0.01 and 100 mW, the intermodulation signal produced by the nonlinear device reaches between 0.01 and 100 pW. The nonlinear device is, but not limited to, a diode, a triode, a ferrite, or the like.

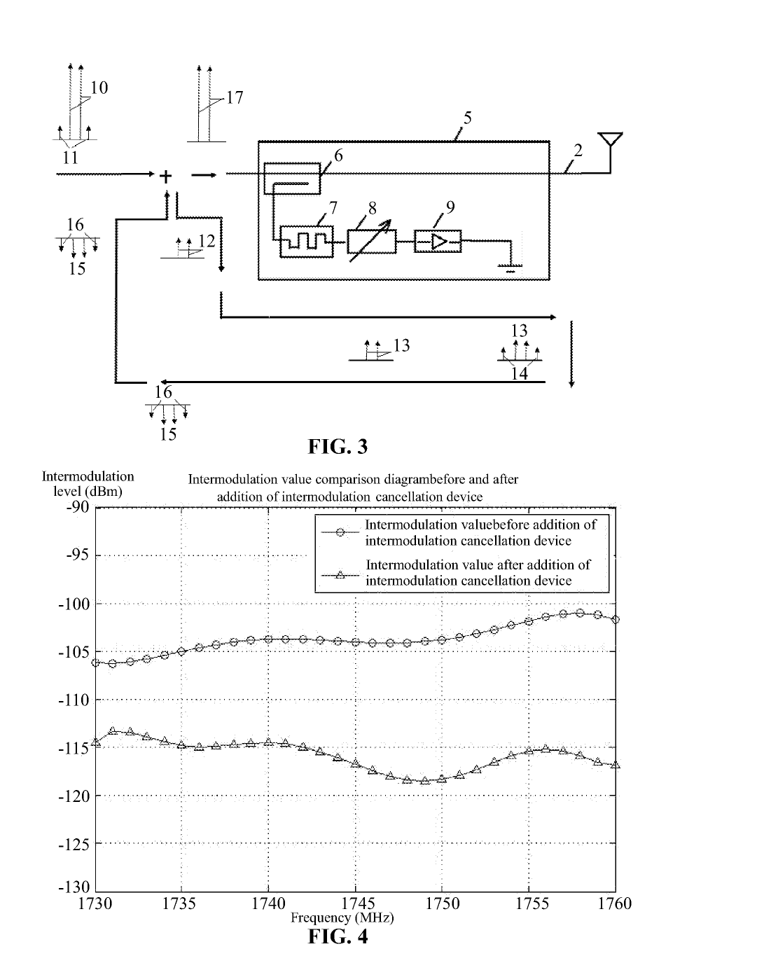

As shown in FIG. 3, the power signal of the transmitted signal of the passive device is 10, the intermodulation signal produced by the transmitted signal when passing the passive nonlinear device is 11. The transmitted signal comprising the intermodulation signal 11 and the power signal 10 is input into the intermodulation cancellation device 5. A small part 12 of the power signal is coupled by the power coupler 6. The power of the power signal 12 is smaller than 2.5% of that of the original power signal 10, and the specific power value of the power signal 12 varies along with change of power of the original power signal 10. After being processed by the phase regulator 7 and the power attenuator 8, the power signal 12 is transformed into a power signal 13. The power signal 13 is processed by an intermodulation production device 9 and produces the intermodulation cancellation signal 14. The power signal 13 and the intermodulation cancellation signal 14 are reflected at an grounded end and then pass through the intermodulation production device 9, the power attenuator 8, and the phase regulator 7 again, so that the power signal 13 is converted into a power signal 15, and the intermodulation cancellation signal 14 is converted into an intermodulation cancellation signal 16. The intermodulation cancellation signal 16 and the intermodulation signal 11 have equivalent frequencies and amplitudes, and a phase difference therebetween is 180 degree. The power signal 15 and the power signal 10 have equivalent frequencies, and the phase difference therebetween is 180 degree, while the level of the power signal 15 is much lower than the power signal 10. Finally, the power signal 15 and the intermodulation cancellation signal 16 are respectively superimposed on the intermodulation signal 11 and the power signal 10 when passing through the power coupler 6. The intermodulation cancellation signal 15 and the intermodulation signal 11 are interactively cancelled, thereby decreasing the power level of the intermodulation signal. The power signal 10 is converted into the power signal 17 after a small part of the power signal 10 is cancelled from by the power signal 15, because that the level of the power signal 10 is much higher than that of the power signal 15, the power signal 17 is approximately the same with the power signal 10, and the influence of the intermodulation cancellation device on the power signal of the transmitted signal is negligible.

The level of the intermodulation signal of the duplexer is cancelled by producing the intermodulation cancellation signal having the same frequency and amplitude with the intermodulation signal and a phase difference of 180 degree between the intermodulation cancellation signal and the intermodulation signal, so that the intermodulation interference of the transmitting pathway on the receiving pathway is reduced. Degrees of the phase adjustment and the power attenuation are based on the phase and the level of the passive intermodulation signal and are realized by an adjustable means, or setting a fixed value, or a combination of the two means. The connection sequences of the phase regulator 7 and the power attenuator 8 are adjustable.

Moreover, only one intermodulation cancellation device 5 is arranged at the antenna port 2 of the duplexer 1. Optionally, a plurality the intermodulation cancellation devices 5 is arranged at the antenna port 2 so as to produce multiple intermodulation cancellation signals which are superimposed to cancel the intermodulation signal of the passive device.

To demonstrate the effect of the intermodulation cancellation device of the invention, intermodulation values of the duplexer before and after addition of the intermodulation cancellation device are measured, and the measurement results are compared in FIG. 4, from which, it is known that within the working frequency band of between 1730 and 1760 MHz, the intermodulation value is larger than −104 dBm before the addition of the intermodulation cancellation device and is smaller than −113 dBm after the addition of the intermodulation cancellation device. The intermodulation value is reduced by at least 9 dB within the whole working efficiency band. The intermodulation cancellation principle of the invention is proved to be feasible.

The intermodulation cancellation device of the invention is also applicable to the intermodulation cancellation of other passive devices, such as the power divider, the coupler, the electric-wave filter, or the antenna.

In summary, compared with the prior art, the intermodulation cancellation device of the invention is able to regulate the level of the intermodulation signal, make the qualified rate easily controllable, decrease the production cost, and is of great significance for the production.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

The invention claimed is:

1. An intermodulation cancellation device, comprising: a power coupler, a regulating module, a nonlinear device, an input/output port, and an end;
wherein
the input/output port functions as a common port for input and output, and the input/output port is disposed at one port of the power coupler;
when in use:
a part of a transmitted signal comprising an intermodulation signal is coupled from a passive device by the power coupler via the input/output port, and a level value of a coupled transmitted signal is much lower than that of the transmitted signal before coupling, and an intermodulation signal of the coupled transmitted signal is negligible;
the coupled transmitted signal is processed for a first time by the regulating module and the nonlinear device, respectively, and a first intermodulation cancellation signal is produced by the nonlinear device after the first processing;
the coupled transmitted signal after the first processing is reflected at the end of the intermodulation cancellation device; the coupled transmitted signal and the first intermodulation cancellation signal produced by the nonlinear device are processed by the nonlinear device and the regulating module for a second time to produce a power signal comprising a second intermodulation cancellation signal, the second intermodulation cancellation signal of the power signal and the intermodulation signal of the transmitted signal of the passive device have the same frequency and level and opposite phases; and
the power signal is superimposed on the transmitted signal of the passive device by the power coupler and a superimposed signal is output to the passive device via the input/output port.

2. The device of claim 1, wherein the intermodulation cancellation device is disposed at an antenna port of the passive device, and the transmitted signal is coupled at the antenna port of the passive device by the power coupler.

3. The device of claim 2, wherein a plurality of the intermodulation cancellation devices is disposed at the same antenna port of the passive device for reaching superimposition effect on the intermodulation signal of the transmitted signal.

4. The device of claim 1, wherein the power signal is coupled by the power coupler within a transmitting frequency band of the passive device.

5. The device of claim 1, wherein a coupling amount of the power coupler is between 16 and 60 dB.

6. The device of claim 1, wherein the nonlinear device functions in that in condition of an input power of between 0.01 and 100 mW in the absence of a DC bias, an intermodulation signal produced by the nonlinear device has an order of magnitude slightly higher than that of a signal to be cancelled, and the order of magnitude is between 0.01 and 100 pW.

7. The device of claim 1, wherein the regulating module comprises: a phase regulator and a power attenuator; the phase regulator is configured to regulate phases of the coupled transmitted signal and the first intermodulation cancellation signal produced by the nonlinear device; and the power attenuator is configured to regulate levels of the coupled transmitted signal and the first intermodulation cancellation signal produced by the nonlinear device.

8. The device of claim 7, wherein the intermodulation cancellation device is formed by series electric connection of the power coupler, the phase regulator, the power attenuator, and the nonlinear device; and the end of the intermodulation cancellation device is grounded or disconnected.

9. A duplexer comprising the intermodulation cancellation device of claim 1, the duplexer comprising: a transmitting port, a receiving port, the antenna port, and the intermodulation cancellation device; the intermodulation cancellation device comprising: the power coupler, the regulating module, the nonlinear device, the input/output port, and the end;
wherein
the intermodulation cancellation device is disposed at the antenna port; the input/output port of the intermodulation cancellation device functions as the common port of the input and the output, and the input/output port is disposed at one port of the power coupler;
when in use:
a part of the transmitted signal comprising the intermodulation signal is coupled from the duplexer by the power coupler via the input/output port, and the level value of the coupled transmitted signal is much lower than that of the transmitted signal before coupling, and the intermodulation signal of the coupled transmitted signal is negligible;
the coupled transmitted signal is processed for the first time by the regulating module and the nonlinear device, respectively, and the first intermodulation cancellation signal is produced by the nonlinear device after the first processing;
the coupled transmitted signal after the first processing is reflected at the end of the intermodulation cancellation device; the coupled transmitted signal and the first intermodulation cancellation signal produced by the nonlinear device are processed by the nonlinear device and the regulating module for the second time to produce the power signal comprising the second intermodulation cancellation signal, the second intermodulation cancellation signal of the power signal and the intermodulation signal of the transmitted signal of the duplexer have the same frequency and level and opposite phases; and
the power signal is superimposed on the transmitted/received signal of the duplexer by the power coupler and the superimposed signal is output to the duplexer via the input/output port.

10. The duplexer of claim 9, wherein the intermodulation cancellation device is disposed at an antenna port of the duplexer, and the transmitted/received signal is coupled at the antenna port of the duplexer by the power coupler.

11. The duplexer of claim 9, wherein a plurality of the intermodulation cancellation devices is disposed at the same antenna port of the duplexer for reaching superimposition effect on the intermodulation signal of the transmitted signal.

12. The duplexer of claim 9, wherein the power signal is coupled by the power coupler within a transmitting frequency band of the duplexer.

13. The duplexer of claim 9, wherein a coupling amount of the power coupler is between 16 and 60 dB.

14. The duplexer of claim 9, wherein the nonlinear device functions in that in condition of an input power of between 0.01 and 100 mW in the absence of a DC bias, an intermodulation signal produced by the nonlinear device has an order of magnitude slightly higher than that of a signal to be cancelled, and the order of magnitude is between 0.01 and 100 pW.

15. The duplexer of claim 9, wherein the regulating module comprises: a phase regulator and a power attenuator; the phase regulator is configured to regulate phases of the coupled transmitted signal and the first intermodulation cancellation signal produced by the nonlinear device; and the power attenuator is configured to regulate levels of the coupled transmitted signal and the first intermodulation cancellation signal produced by the nonlinear device.

16. The duplexer of claim 9, wherein the intermodulation cancellation device is formed by series electric connection of the power coupler, the phase regulator, the power attenuator, and the nonlinear device; and the end of the intermodulation cancellation device is grounded or disconnected.

17. A method for cancel an intermodulation signal of a passive device, the method comprising:
a) coupling a part of a transmitted signal comprising an intermodulation signal from a passive device by an intermodulation cancellation device, wherein a level value of a coupled transmitted signal is much lower than that of the transmitted signal before coupling, and an intermodulation signal of the coupled transmitted signal is negligible;
b) processing the coupled transmitted signal for a first time by the intermodulation cancellation device to enable the coupled transmitted signal to produce a first power signal comprising a first intermodulation cancellation signal;
c) reflecting the first power signal at an end of the intermodulation cancellation device to return the first power signal along an original path, processing the coupled transmitted signal for a second time to enable the coupled transmitted signal to produce a second power signal comprising a second intermodulation cancellation signal, wherein the second intermodulation cancellation signal of the second power signal and the intermodulation signal of the transmitted signal in the passive device have the same frequency and level and opposite phases;
d) superimposing the second power signal on a transmitted/received signal of the passive device and outputting a superimposed signal from the intermodulation cancellation device to the passive device.

18. The method of claim 17, wherein the transmitted/received signal is coupled by the intermodulation cancellation device within a transmitting frequency band of the passive device.

19. The method of claim 17, wherein a coupling amount of the transmitted/received signal coupled by the power coupler is between 16 and 60 dB.

20. The method of claim 17, wherein the regulating module comprises a phase regulator and a power attenuator; the phase regulator is configured to regulate phases of the coupled transmitted signal and the first intermodulation cancellation signal produced by the nonlinear device; and the power attenuator is configured to regulate levels of the coupled transmitted signal and the first intermodulation cancellation signal produced by the nonlinear device.
